(19) United States
(12) Patent Application Publication
(10) Pub. No.: US 2002/0032242 A1
(43) Pub. Date: Mar. 14, 2002

(54) Polyadditions in aqueous and non-aqueous miniemulsions

(76) Inventors: Markus Antonietti, Bergholz-Rehbrucke (DE); Katharina Landfester, Berlin (DE); Franca Tiarks, Berlin (DE); Nina Bechthold, Essen (DE); Mirjam Willert, Berlin (DE)

Correspondence Address: KILPATRICK STOCKTON LLP, Attn: John K. McDonald, Ph.D., Suite 2800, 1100 Peachtree Street, Atlanta, GA, 30309-4530, US

(21) Appl. No.: 09/858,709

(22) Filed: May 16, 2001

Related U.S. Application Data
(63) Continuation-in-part of application No. PCT/EP99/08789, filed on Nov. 16, 1999.

(30) Foreign Application Priority Data
Jul. 22, 1999 (DE) 199 34 519.8
Nov. 16, 1998 (DE) 198 52 784.5

(51) Int. Cl. C09K 3/00

(52) U.S. Cl. 516/98

(57) ABSTRACT

The invention relates to a method for carrying out polyaddition reactions in mini-emulsions.

### Description

The invention relates to a method of conducting polyaddition reactions in miniemulsions.

Miniemulsion polymerization is an innovative process of heterophase polymerization which extends the field of use of conventional emulsion polymerization. Miniemulsions are dispersions of an aqueous phase, an oil phase, and, if desired, one or more surfactants, in which unusually small droplet sizes are realized. In the case of polymerization reactions in miniemulsions, an apolar monomer or a mixture of monomers and, if desired, a cosurfactant is dispersed in water using a surfactant and high shear fields to form droplets of the desired size, which are colloidally stabilized by the added surfactant (Sudol and El-Aasser in: Emulsion Polymerization and Emulsion Polymers; Lovell, P. A.; El-Aasser, M. S., eds., Chichester (1997), 699). In such miniemulsions, the droplet size may grow further owing to collisions and fusions.

The German patent application 198 52 784.5-43 describes the osmotic stabilization of miniemulsions and microemulsions through the use of water-insoluble compounds as emulsion-stabilizing component. By adding the water-insoluble substance to the oil phase, which is normally the disperse phase of the emulsion, an osmotic pressure is built up which counteracts the capillary pressure or Kelvin pressure built up by the surface tension of the emulsion droplets. The consequence of this is to prevent or retard Ostwald ripening of the emulsion droplets.

Preparation of polyaddition products by heterophase techniques has not been described to date. Indeed, aqueous polyurethane dispersions and polyepoxide dispersions are already available on the market. These dispersions, however, are prepared in a technically complex process as secondary dispersions, by condensing the polyurethane or polyepoxides in an organic solvent, introducing them into water, and then removing the organic solvent. Other aqueous polyurethanes comprise readily water-soluble amines and thus are themselves water-soluble, at least in part, and consequently do not represent a dispersion in the strict sense.

It has surprisingly been found that polyadditions may be conducted in miniemulsions with retention of the particulate character. In these procedures, the reactants used for the polyaddition, e.g., diamines and diepoxides for preparing polyepoxide dispersions or diisocyanates and diamines and/or dialcohols for preparing polyurethane dispersions and/or polyurea dispersions, are dispersed in a suitable dispersion medium, preferably with the aid of a surfactant and, if desired, one or more water-insoluble substances, and are brought to reaction, for example, by adding a catalyst and/or increasing the temperature. In this way, the desired polymer dispersion is formed directly. By varying the stoichiometry between both reactants it is also possible to obtain functional polymers, functional particles, and even, by adding crosslinking agents, functional microgels. The use of such dispersions is possible in all areas in which aqueous polyepoxide dispersions and/or polyurethane dispersions are already currently in use, i.e., in particular, in adhesives, topcoats, and coating materials.

The present invention firstly provides a method of conducting polyaddition reactions in miniemulsions, which is characterized in that a miniemulsion comprising the reactants of the polyaddition reactions is produced in a fluid medium and then brought to reaction, giving a dispersion of particles of the polyaddition product in the medium. Polyadditions in the sense of the present invention are polymerizations which proceed in stages without the elimination of byproducts and in which polyaddition products—polyadducts—are built up by multiply repeated addition of difunctional or polyfunctional reactants in independent individual reactions (stage reactions) via the formation of reactive oligomers as discrete intermediates. They include both unipolyaddition reactions, starting from two monomer types, and copolyaddition reactions, in which more than two different monomer types are used. Preferred examples of polyaddition reactions are the preparation of polyurethanes from polyfunctional hydroxy compounds and polyfunctional isocyanates, the preparation of polyureas from polyfunctional amines and polyfunctional isocyanates, and the preparation of polyepoxides from polyfunctional epoxides and polyfunctional amines, thiols and/or hydroxy compounds.

The miniemulsion in which the polyaddition reaction is conducted may be set by using high shear fields, e.g., by means of a rod-type ultrasonicator, a jet disperser or a microfluidizer. The average particle diameter of the emulsion droplets preferably is from 20 to 1 000 nm, in particular, from 30 nm to 600 nm. Preferably, a miniemulsion of an oil phase in a hydrophilic phase substantially immiscible therewith, e.g., a polar organic phase, but in particular an aqueous phase, is formed.

To stabilize the emulsion it is preferred to add surfactants such as, for instance, sodium dodecyl sulfate, cetyltrimethylammonium chloride or else polymeric surfactants, such as block copolymers of styrene and ethylene oxide, for example. The amount of surfactant is preferably in the range from 0.1 to 20% by weight, more preferably from 0.2 to 10% by weight, and with particular preference from 0.5 to 5% by weight, based on the overall weight of the emulsion.

In many cases the presence of a hydrophobic addition component, i.e., one of the reactants, is sufficient for osmotic stabilization of the dispersion.

Where polar dispersion media, especially aqueous dispersion media, are used, however, it is additionally possible to add ultrahydrophobic compounds which are inert—i.e., which do not participate in the polyaddition reaction—and insoluble in the dispersion medium, generally in an amount of from 0.1 and 40% by weight, preferably from 0.2 to 10% by weight, and with particular preference from 0.5 to 5% by weight, based on the overall weight of the emulsion.

Particularly suitable ultrahydrophobic compounds in this context are those which mix with the oil phase and have a solubility in the dispersion medium of preferably less than 5×10⁻⁵ g/l, with particular preference less than 5×10⁻⁶ g/l, and most preferably less than 5×10⁻⁷ g/l, at room temperature. Examples thereof are hydrocarbons, especially volatile and optionally halogenated hydrocarbons, silanes, organosilanes, siloxanes, long-chain esters, oils such as vegetable oils, e.g., olive oil, hydrophobic dye molecules, capped isocyanates, and also oligomeric products of polymerization, polycondensation, and polyaddition.

The surfactants and ultrahydrophobic compounds are preferably selected so as to be compatible with the resultant polyadduct. Thus it is possible to use substances which possess a high volatility and/or which are usefully employed in the context of any further use of the polymeric dispersion, e.g., as plasticizer, dye, etc., so that they may contribute positively to the intended application. By varying the surfactants and/or the ultrahydrophobic compounds and/or their amounts in the reaction batch it is possible to adjust as desired the particle size of the emulsion and also of the resultant polymer dispersion.

The polyaddition reaction in the miniemulsion may be initiated in a known way, for example, by adding a catalyst and/or by raising the temperature. In this case, the preferred starting point is a critically stabilized emulsion, with particular preference a thermodynamically stable emulsion. In the case of emulsions osmotically stabilized in this way, it is possible to obtain polyadduct dispersions whose particle size has not undesirably changed relative to that of the reactants emulsion. The particles of the polyadduct have an average size of preferably from 20 to 1000 nm and with particular preference from 30 to 600 nm.

Furthermore, the method of the invention is also suitable for preparing multiphase nanohybrid particles, e.g., particles which comprise polyadducts and—encapsulated therein—inert particulate solids, e.g., inorganic materials such as metal colloids, oxidic particles such as SiO₂, TiO₂, CaSO₄, CaCO₃, BaSO₄, zeolites, iron oxides, ZnO, CuO, CrO₂, ZrO₂, fluoroapatites and hydroxyapatites, and fine carbon black, or organic materials, such as colloidal dye aggregates. Preferably, particulate solids having a hydrophobic or hydrophobicized surface are encapsulated. The hydrophobicization of the surface may take place by adding substances which form a monolayer on the particulate solids, e.g., long-chain carboxylic acids. Furthermore, it is also possible to use reactants for or products (which should then be used in small amounts as an admixture) of polyaddition for hydrophobicizing the abovementioned particles. The size of the particulate solids is generally situated in the range from 0.5 to 400 nm, preferably in the range from 1 to 250 nm, and with particular preference in the range from 10 nm to 200 nm. The size of the emulsion droplets is tailored to the size of the particulate solids that are to be encapsulated.

In the case of polyadditions in miniemulsions, especially in osmotically stabilized emulsions, it is possible to achieve efficient embedding of particulate solids into the shell of polyadducts. Preferably at least 60%, with particular preference at least 80%, more preferably still at least 90%, and most preferably at least 95% of the particulate solids are embedded. The dispersions obtained by polyaddition may be filmed homogeneously, with the resultant films exhibiting high mechanical stability and acid resistance. Owing to the homogeneous encapsulation, the resultant nanohybrid particles may be used, for example, for paints or coatings with a high coloristic efficiency.

The encapsulation of particulate solids into the particles of the polyadduct may be detected using transmission electron microscopy and/or ultra-centrifugation.

Furthermore, the invention is to be illustrated by means of the following figures and examples:

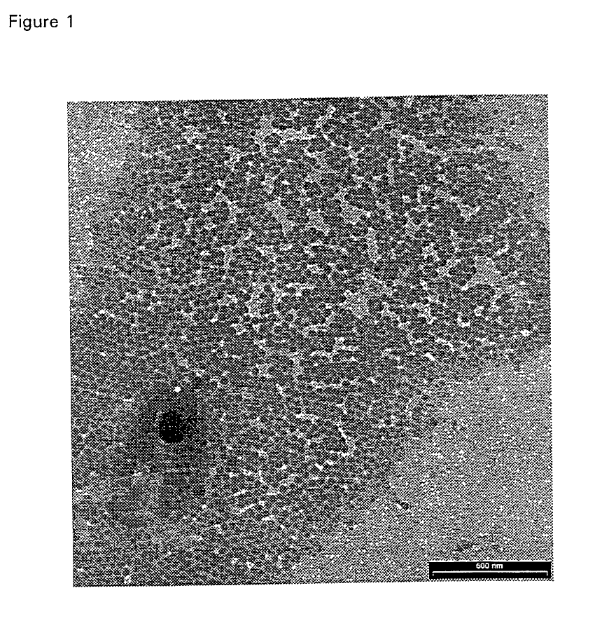

FIG. 1 shows an electron micrograph of a latex prepared by polyaddition of Epikote E828 and 4,4′-diaminobibenzyl.

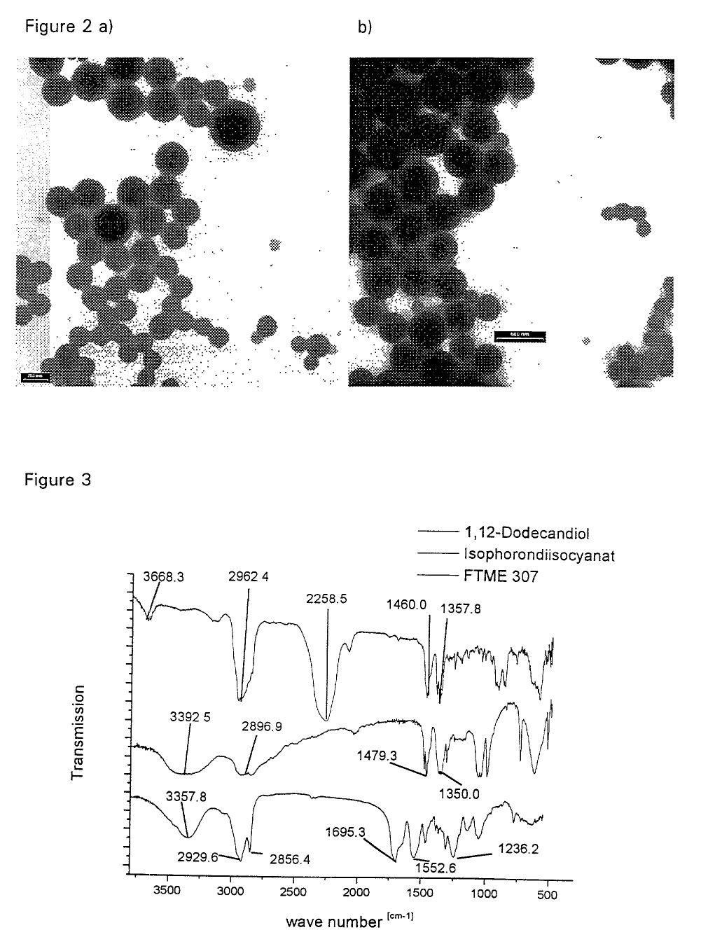

FIG. 2 a) shows a typical TEM picture of a polyurethane latex consisting of isophorone diisocyanate and 1,12-dodecane diol; b) shows polyurethane latices consisting of isophorone diisocyanate and bisphenol A.

FIG. 3 shows the IR spectra of the reactants, 1,12-dodecane diol and isophorone diisocyanate, and the polymer obtained by miniemulsion polymerization. The spectra show the reaction of the diisocyanate.

### EXAMPLES

### Example 1

6 g of a monomer mixture of Epikote E828 and Jeffamin D2000 (for structures see Table 1) in a molar ratio of 2:1 were added to a solution of 1 g of sodium dodecyl sulfate (surfactant) and 40 g of water and stirred for 1 h at the highest magnetic stirrer setting. The mixture was miniemulsified using a rod-1type ultrasonicator (Branson Sonifier W450 Digital, amplitude 90%) at from 110 to 115 W for 2 min. By raising the temperature to 60° C., the reaction was started. The reaction time was 12 h. A stable dispersion of an amine-epoxide polyadduct was obtained.

The particle size was measured using a Nicomp Particle Sizer (model 370, PSS, Santa Barbara, USA) at a fixed scatter angle of 90°. The molecular weights of the polymers were determined by means of GPC analysis, conducted using a P1000 pump and a UV1000 detector (Thermo Separation Products) at a wavelength of 260 nm with 5 μm 8×300 mm SDV columns with 10⁶, 10⁵ and 10³ angströms, respectively (Polymer Standard Service) in THF with a flow rate of 1 ml/min at 30° C. The molecular weights were calculated on the basis of a calibration relative to the standards.

Electron micrographs were taken using a Zeiss/912 Omega electron microscope at 100 kV. The diluted particle dispersions were applied to a 400 mesh carbon-coated copper grid and left to dry.

By varying the amount of surfactant (0.1 g, 0.5 g, 2.5 g and 4.0 g of sodium dodecyl sulfate) it was possible to vary the size of the resultant latex particles in the range from approximately 80 nm to 250 nm.

By varying the monomer (1, 12-diaminododecane) and the surfactant (styrene/ethylene oxide block copolymer SE3030 (Sty)₁₀-b-(EO)₂₃) it was likewise possible to vary the particle size.

The results are summarized in Table 2.

### Example 2

In accordance with the instructions indicated in Example 1, cetyltrimethylammonium chloride (CTMA-CI), Lutensol AT50 (C₁₆H₃₃)(EO)₅₀ and also the styrene/ethylene oxide block copolymers PS/PE01000/1050 (Sty)₁₀-b-(EO)₁₁₄ and SE1030 (Sty)₃₀-b-(EO)₂₃ were used instead of sodium dodecyl sulfate or SE3030 as surfactants. Particle sizes in the range between approximately 90 and 400 nm were obtained.

The results are shown in Table 3.

### Example 3

Instead of a monomer mixture with the molar ratio of epoxide to diamine of 2:1, one component in each case was added in excess.

(a) Epoxide was added in excess in a molar ratio of epoxide to amine of from 2:1 to 3.3:1.

(b) The amine was added in excess in a molar ratio of epoxide to amine of from 1:1.22 to 1 :1.5.

This gave functional polyadducts containing free primary amine groups or epoxide groups, respectively, which may be used as starting products for further reaction steps.

The results of this experiment are shown in Table 4 A.

By acidifying the latex, it was possible to reduce the particle size. The results are shown in Table 4 B.

### Example 4

The experiment described in Example 1 was repeated using the amines 4,4′-diaminobibenzyl, 1,12-diaminododecane and 4, 4′-diaminodicyclohexylmethane (for structures see Table 1). This gave polymer dispersions having particle sizes in the range from approximately 40 to 75 nm.

The results are shown in Table 5. FIG. 1 is an electron micrograph of the latex prepared using 4,4′-diaminobibenzyl.

### Example 5

6 g of a monomer mixture of Epikote E828 and bisphenol A (for structure see Table 1) were added in a molar ratio of 1:1 to a solution of 1 g of sodium dodecyl sulfate and 40 g of water and stirred for 1 h at the highest magnetic stirrer setting. In accordance with the instructions indicated in Example 1, a miniemulsion was prepared and reacted.

Analogously, by using 6 g of a monomer mixture of Epikote E828 and hexanedithiol (for structure see Table 1) in a ratio of 1:1, a stable dispersion of a polysulfide was obtained.

The results are depicted in Table 6.

### Example 6

6 g of a monomer mixture of the trifunctional epoxide Denacol Ex-314 (for structure see Table 1) and Jeffamin D2000 in a molar ratio of 1:1.05 and 1:1.1 were added to a solution of 1 g of sodium dodecyl sulfate and 40 g of water and stirred for 1 h at the highest magnetic stirrer setting. In accordance with the instructions described in Example 1, a miniemulsion was prepared and reacted.

The experiment was repeated using the difunctional epoxide Epikote E828, the tetrafunctional epoxide Ex-411, and also with mixtures of a difunctional and a trifunctional epoxide and, respectively, of a difunctional and a tetrafunctional epoxide.

The results are depicted in Table 7.

### Example 7

6 g of a monomer mixture of isophorone diisocyanate and 1, 12-diaminododecane or 4,4′-diaminobibenzyl, in each case in a molar ratio of 1:1, were added to a solution of 1 g of sodium dodecyl sulfate and 40 g of water and stirred for 1 h at the highest magnetic stirrer setting. The mixture was miniemulsified with the instrument already used in Example 1 with an amplitude of 90% (from 110 to 115 W) for 2 min (in the case of diaminobibenzyl, 12 min). The reaction was started by raising the temperature to 60° C. The reaction time was 12 h.

The results of this experiment are depicted in Table 8.

### Example 8

6.4 g of the monomer mixture of 3.4 g isophorone diisocyanate, 3.0 g 1,12-dodecane diol (molar ratio of 1:1) and 150 mg hexadecane (hydrophobic) were added to a solution of various amounts of tenside in water. After 1 h high-speed stirring at the highest magnetic stirrer setting the miniemulsion was prepared by ultrasound treatment of the mixture at room temperature (120 s at an amplitude of 90%, using a Branson Sonifier W450 Digital). Polymerization was effected overnight at 68° C. Particle sizes were from 200 to 230 nm. The amount of coagulate increased with the amount of tenside decreasing.

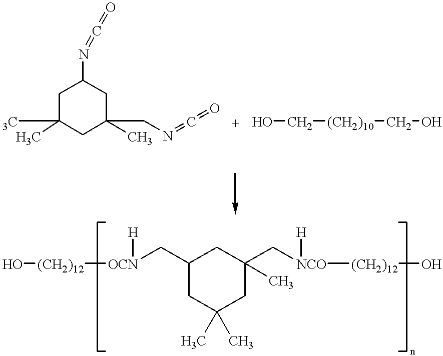

### Example 9

as in Example 8, with bisphenol A being used as diol component instead of 1,12-dodecane diol.

### Example 10

as in Example 8, with toluylene-2,4-(and 2,6)-diisocyanate (Lupranat T80A) being used as isocyanate component instead of isophorone diisocyanate.

| 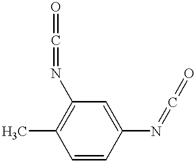 | 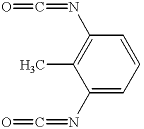 |
|---|---|
| Lupranat T80A | |
| 80% toluylene-2,4-diisocyanate | 20% toluylene-2,6-diisocyanate |

### Example 11

as in Example 8, with 50 mole % of diol being replaced by neopentyl glycol.

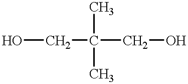

Neopentylglycol

The results of Examples 8 to 11 are summarized in Tables 9 and 10.

TABLE 1
Overview of the monomer components used

| | |
|---|---|
| Epoxides | |
| Epikote 828 | 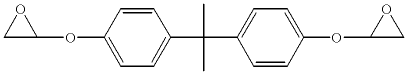 |
| Denacol Ex-314 | 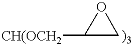 |
| Denacol Ex-411 | 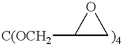 |
| Amines | |
| Jeffamin D2000 | 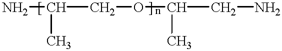 |
| 4,4′Diaminobibenzyl | 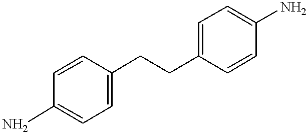 |
| 1,12 Diaminododecane | NH₂—(CH₂)₁₂—NH₂ |
| 4,4′Diaminodicyclo-hexylmethane | 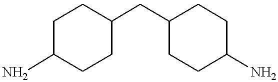 |
| Dithiol | |
| Hexanedithiol | HS—(CH₂)₆—SH |
| Diol | |
| Bisphenol A | 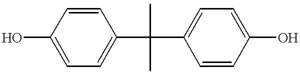 |

TABLE 2

| | | | |
|---|---|---|---|
| | | Surfactant | Diameter |
| Example | Monomer | [g] | [nm] |

| | | | | |
|---|---|---|---|---|
| 1 | Jeffamin D2000 | SDS | 0.1 | 245 |
| 1 | Jeffamin D2000 | SDS | 0.5 | 99 |
| 1 | Jeffamin D2000 | SDS | 1.0 | 90 |
| 1 | Jeffamin D2000 | SDS | 2.5 | 83 |
| 1 | Jeffamin D2000 | SDS | 4.0 | 160 |
| 1 | 1,12-Diaminododecane | SDS | 0.05 | 816 |
| 1 | 1,12-Diaminododecane | SDS | 0.1 | 759 |
| 1 | 1,12-Diaminododecane | SDS | 0.25 | 358 |
| 1 | 1,12-Diaminododecane | SDS | 0.5 | 121 |
| 1 | 1,12-Diaminododecane | SDS | 1.5 | 36 |
| 1 | Jeffamin D2000 | SE3030 | 1.25 | 193 |
| 1 | Jeffamin D2000 | SE3030 | 2.5 | 175 |
| 1 | Jeffamin D2000 | SE3030 | 3.0 | 93 |
| 1 | 1,12-Diaminododecane | SE3030 | 1.25 | 143 |
| 1 | 1,12-Diaminododecane | SE3030 | 2.5 | 71 |
| 1 | 1,12-Diaminododecane | SE3030 | 3.0 | 45 |

TABLE 3

| | | |
|---|---|---|
| | Surfactant | Diameter |
| Example | [g] | [nm] |

| | | | |
|---|---|---|---|
| 2 | CTMA-Cl | 2 | 302 |
| 2 | PS/PEO 1000/5000 | 2.5 | 377 |
| 2 | Lutensol AT 50 | 2.5 | 179 |
| 2 | SE 1030 | 2.5 | 377 |

TABLE 4 A

| | | |
|---|---|---|
| Ratio | | |
| Epikote E828/ | Surfactant | Diameter |
| Jeffamin D2000 | [g] | [nm] |

| | | | |
|---|---|---|---|
| 2:1 | CTMA-Cl | 2.0 | 302 |
| 1:1.5 | CTMA-Cl | 2.0 | 323 |
| 3:1 | CTMA-Cl | 2.0 | 228 |
| 2:1 | SDS | 0.5 | 172 |
| 1:1.22 | SDS | 0.5 | 552 |
| 3.3:1 | SDS | 0.5 | 183 |
| 2:1 | SDS | 2.5 | 231 |
| 1:1.22 | SDS | 2.2 | 580 |
| 2.8:1 | SDS | 2.5 | 201 |

TABLE 4 B

| | | |
|---|---|---|
| Ratio | | |
| Epikote E828/ | Surfactant | Diameter |
| Jeffamin D2000 | [g] | [nm] |

| | | | |
|---|---|---|---|
| 2:1 | SDS | 0.5 | 99 |
| 1:1.22 | SDS | 0.5 | 102 |
| 2:1 | SDS | 2.5 | 83 |
| 1:1.22 | SDS | 2.2 | 163 |

TABLE 5

| | | |
|---|---|---|
| Monomer | Surfactant | Diameter |
| [g] | [g] | [nm] |

| | | | |
|---|---|---|---|
| Jeffamin D2000 | SDS | 1.0 | 90 |
| 1,12-Diaminododecane | SDS | 1.5 | 36 |
| 4,4′-Diaminodicyclohexylethane | SDS | 1.5 | 39 |
| 4,4′-Diaminobibenzyl | SDS | 1.5 | 30 |

TABLE 6

| | | |
|---|---|---|
| | Surfactant | Diameter |
| Monomer | [g] | [nm] |

| | | | |
|---|---|---|---|
| 1,6-Hexanedithiol | SDS | 1.0 | 194 |
| Bisphenol A | SDS | 1.0 | 243 |

TABLE 7

| | | | |
|---|---|---|---|
| Epoxide/ | Monomer | Surfactant | Diameter |
| amine | (epoxide) | [g] | [nm] |

| | | | | |
|---|---|---|---|---|
| 2:1 | Epikote E828 | SDS | 1.0 | 83 |
| 1:1.05 | Denacol Ex-314 | SDS | 1.0 | 193 |
| 1:1.1 | Denacol Ex-314 | SDS | 1.0 | 495 |
| 1:1.05 | Denacol Ex-411 | SDS | 1.0 | 295 |
| 1:1.1 | Denacol Ex-411 | SDS | 1.0 | 158 |
| 1:2 | 1:1 Epikote E828/ | SDS | 1.0 | 117 |
| | Denacol Ex-411 | | | |
| 1:2 | 1:1 Epikote E828/ | SDS | 1.0 | 74 |
| | Denacol Ex-314 | | | |

TABLE 8

| | | |
|---|---|---|
| Monomer | Surfactant | Diameter |
| (amine) | [g] | [nm] |

| | | | |
|---|---|---|---|
| 1,12-Diaminododecane | SDS | 1.0 | approx. 80 |
| 4,4′-Diaminobibenzyl | SOS | 1.0 | approx. 60 |

TABLE 9
Characteristics of the latices containing isophorone
diisocyanate

| | | | | | | | | | Particle | σ |
|---|---|---|---|---|---|---|---|---|---|---|
| | Monomer | | Tenside | | H₂O | Hydrophobic | | Coagulate | size | [mN/ |
| Latex | [g] | | [g] | | [g] | [g] | | [%] | [nm] | m] |
| FTME338 | isophorone | 3.5 | SDS | 0.25 | 30.1 | HD | 0.15 | <5 | 202 | 41.8 |
| | diisocyanate | | | | | | | | | |
| | 1,12-dodecane diol | 3.0 | | | | | | | | |
| FTME339 | Isophorone | 3.4 | SDS | 0.1 | 30.2 | HD | 0.15 | <5 | 208 | 50.9 |
| | diisocyanate | | | | | | | | | |
| | 1,12-dodecane diol | 3.0 | | | | | | | | |
| FTME349 | Isophorone | 3.4 | SDS | 0.05 | 30.6 | HD | 0.15 | 15 | 232 | 55.4 |
| | diisocyanate | | | | | | | | | |
| | 1,12-dodecane diol | 3.0 | | | | | | | | |
| FTME350 | Isophorone | 3.4 | SDS | 0.025 | 30.6 | HD | 0.15 | 43 | 229 | 57.6 |
| | diisocyanate | | | | | | | | | |
| | 1,12-dodecane diol | 3.0 | | | | | | | | |
| FTME361 | Isophorone | 3.3 | SDS | 0.1 | 20.2 | HD | 0.25 | <5 | 228 | 46.1 |
| | diisocyanate | | | | | | | | | |
| | bisphenol A | 3.4 | | | | | | | | |

TABLE 10
Characteristics of a) the polyurethane latices consisting of
toluylene-2,4(and 6)-diisocyanate and 1,12-dodecane diol;
b) the polyurethane latices containing neopentyl glycol

| | | | | | | | |
|---|---|---|---|---|---|---|---|
| | | | | | | Particle | |
| | Monomer | Tenside | H₂O | Hydrophobic | Coagulate | size | σ |
| Latex | [g] | [g] | [g] | [g] | [%] | [nm] | [mN/m] |

a)

| | | | | | | | | |
|---|---|---|---|---|---|---|---|---|
| FTME314 | toluylene-2,4-(and 6)- | 3.0 | SDS | 0.3 | 20.3 | HD | 0.13 | 80 |
| | diisocyanate | | | | | | | |
| | 1,12-dodecane diol | 0.26 | | | | | | |

b)

| | | | | | | | | | | |
|---|---|---|---|---|---|---|---|---|---|---|
| FTME366 | isophorone diisocyanate | 3.4 | SDS | 0.25 | 20.2 | HD | 0.25 | — | 167 | 35.6 |
| | 1,12-dodecane diol | 2.0 | | | | | | | | |
| | neopentyl glycol | 0.5 | | | | | | | | |
| FTME368 | isophorone diisocyanate | 3.3 | SDS | 0.25 | 20.0 | HD | 0.25 | — | 232 | 36.6 |
| | bisphenol A | 2.3 | | | | | | | | |
| | neopentyl glycol | 0.5 | | | | | | | | |
| FTME370 | Lupranol 1000 | 1.0 | SDS | 0.25 | 20.1 | HD | 0.15 | — | 163 | 35.6 |
| | Lupranat T 80 | 0.26 | | | | | | | | |
| | neopentyl glycol | 0.5 | | | | | | | | |

1. A method of conducting polyaddition reactions in miniemulsions, characterized in that a miniemulsion comprising the reactants of the polyaddition reaction is produced in a fluid medium and then brought to reaction.

2. The method as claimed in claim 1, characterized in that the polyaddition reaction comprises a preparation of polyurethanes from polyfunctional hydroxy compounds and polyfunctional isocyanates.

3. The method as claimed in claim 1, characterized in that the polyaddition reaction comprises a preparation of polyureas from polyfunctional amino compounds and polyfunctional isocyanates.

4. The method as claimed in claim 1, characterized in that the polyaddition reaction comprises a preparation of polyepoxide compounds from polyfunctional amino, hydroxy and/or thiol compounds and polyfunctional epoxides.

5. The method as claimed in one of the preceding claims, characterized in that a miniemulsion of a disperse oil phase in a continuous hydrophilic phase, especially an aqueous phase, is formed.

6. The method as claimed in one of the preceding claims, characterized in that a surfactant is added.

7. The method as claimed in one of the preceding claims, characterized in that additionally a hydrophobic inert substance is introduced into the system.

8. The method as claimed in claim 7, characterized in that the hydrophobic substance is used in an amount of 0.1-40% by weight, based on the overall weight of the emulsion.

9. The method as claimed in one of the preceding claims, characterized in that the average particle size of the emulsion is situated in a range from 30 to 600 nm.

10. The method as claimed in one of the preceding claims, characterized in that an emulsion is produced which is critically stabilized or thermodynamically stable in relation to a change in the particle size.

11. The method as claimed in one of the preceding claims, characterized in that the emulsion further comprises particulate solids dispersed therein.

12. The method as claimed in one of the preceding claims, characterized in that the polyaddition reaction takes place without substantial change in the particle size.
